(19) United States
(12) Patent Application Publication
(10) Pub. No.: US 2022/0114351 A1
(43) Pub. Date: Apr. 14, 2022

(54) SYSTEM AND METHOD FOR DETECTING A SMART CARD

(71) Applicant: NCR Corporation, Duluth, GA (US)

(72) Inventors: Shannon McGrath, Perth (GB); Rajveer Singh, Kirkcaldy (GB)

(21) Appl. No.: 17/070,161

(22) Filed: Oct. 14, 2020

(51) Int. Cl. G06K 7/00; G06N 20/00; G06K 7/08; G06T 7/00

(52) U.S. Cl. CPC G06K 7/0069; G06N 20/00; G06Q 20/341; G06K 7/087; G06T 7/0008; G06K 7/0052

(57) ABSTRACT

A card reader for reading a bank card and a method of use thereof is disclosed. The card reader housing has a card entry slot where a customer inserts a bank card, either a magnetic stripe card or a chip-based smart card. A camera is mounted adjacent to the card entry slot in a position to allow an image to be taken of an upper surface of a bank card inserted into the card entry slot. A chip reader unit reads the chip-based smart card. A controller is coupled to the camera and to the chip reader unit. The controller processes an image received from the camera to determine that the inserted bank card is a chip-based smart card in a proper orientation. The controller enables the chip reader unit upon determining that the inserted bank card is a chip-based smart card in proper orientation.

### FIELD

This disclosure relates generally to a system and method for detecting the presence and orientation of a chip-based smart card.

### BACKGROUND

Credit cards originally provided account data only by way of characters embossed on the face of the card that indicated the name of the cardholder, the account number, and an expiration date. Later, a magnetic stripe was added to the outer surface of the back of credit and debit cards that contained customer information including, inter alia, the account number and expiration date. The banking industry has been transitioning away from magnetic stripe-based credit or debit cards to credit and debit cards based on an embedded integrated circuit (smart cards or chip cards) to provide the customer information required to verify transactions. Europay MasterCard Visa (“EMV”) is a technical standard for payment terminals and automated teller machines that accept these types of smart payment cards. Smart cards which comply with the EMV standard are known as EMV cards. During this transition period, EMV cards have included both a magnetic stripe and an embedded integrated circuit (chip). However, as more and more countries become EMV-compliant, some banks have started to issue EMV cards without magnetic stripes. It is expected that this trend will continue. This raises problems for manufacturers of card reader equipment, because card readers have traditionally detected that a magnetic stripe-based credit or debit card (whether or not a chip is included) has been inserted into the card reader in a proper orientation based on a successful reading of the magnetic stripe on such card. The card reader will not be able to read the magnetic stripe on a magnetic stripe-based credit or debit card if it is inserted backwards or upside down. In addition, banks have also begun issuing smart cards based on a metal substrate, instead of plastic. This makes it difficult to design equipment that detects orientation of a metal-substrate smart card based on only metal detection (i.e., detecting the metal that is part of the embedded integrated circuit).

Accordingly, because banks have begun issuing credit or debit cards which rely on an integrated circuit embedded within such card to provide account information for such card, in place of a magnetic stripe placed on the outer surface of the card, there is a need for a system and method for detecting the presence and orientation of a chip-based smart card without detecting and reading a magnetic stripe thereon.

### BRIEF DESCRIPTION OF THE DRAWINGS

The following detailed description, given by way of example and not intended to limit the present disclosure solely thereto, will best be understood in conjunction with the accompanying drawings in which:

FIG. 1 is a front view of a motorized card reader device according to an embodiment of the present disclosure;

FIG. 2 is a simplified side view of the device of FIG. 1;

FIG. 3 is a rear view of a magnetic stripe card for use with the device of FIGS. 1 and 2;

FIG. 4 is a front view of a chip-based smart card for use with the device of FIGS. 1 and 2;

FIG. 5 is a simplified block diagram of the device of FIGS. 1 and 2; and

FIG. 6 is a flowchart showing the operation of the device of FIGS. 1 and 2.

### DETAILED DESCRIPTION

In the present disclosure, like reference numbers refer to like elements throughout the drawings, which illustrate various exemplary embodiments of the present disclosure.

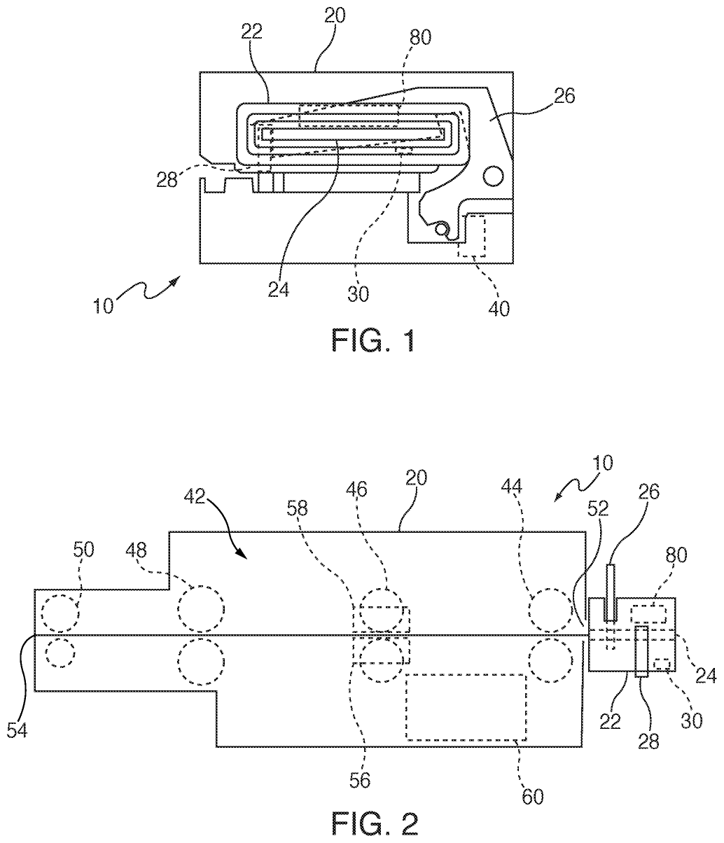

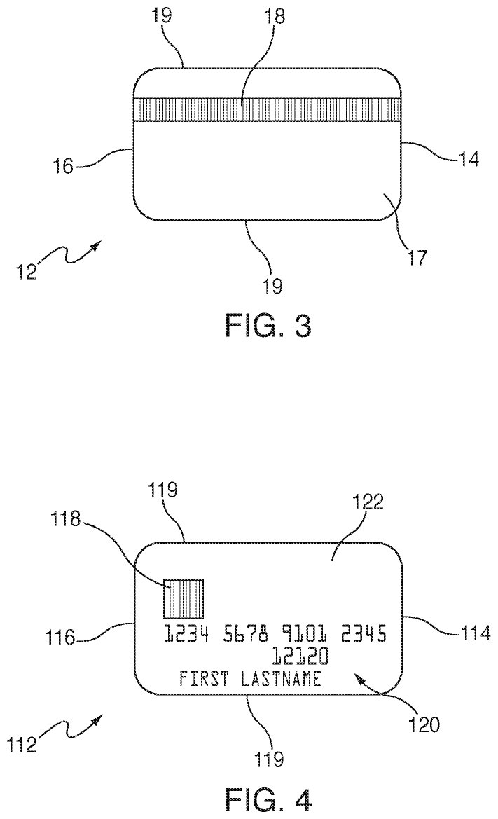

Referring now to FIGS. 1 and 2, respective front and side views are depicted of a motorized card reader 10 that detects the presence and orientation of a chip-based smart card without reading the chip. Card reader 10 is often referred to as a motorized card reader/writer (MCRW) device. Reference is also made to FIG. 3 which is a rear view of a magnetic stripe card 12 for use with the card reader 10 and to FIG. 4 which is a front view of a chip-based smart card 112. The card reader 10 is intended to be incorporated into a self-service terminal, such as an automated teller machine (ATM), a non-cash kiosk, a self-checkout terminal, a check-in/check-out terminal, or the like. Magnetic stripe card 12 and chip-based smart card 112 are two versions of credit or debit cards (collectively “bank cards” or a “bank card” hereinafter) for use with a self-service terminal.

The magnetic stripe card 12 has a leading edge 14 opposite a trailing edge 16, and a magnetic stripe 18 extending from the leading edge 14 to the trailing edge 16 parallel to long edges 19 on a rear side 17. The chip-based smart card 112 has a leading edge 114 opposite a trailing edge 116, and two long edges 119. Chip-based smart card 112 also has a chip 118 on a front side 122 along with embossed information 120 including, for example, an account number, expiration date, and name. Chip-based smart card 112 may also include a magnetic stripe on a rear side (opposite to front side 122) or such magnetic stripe may be omitted.

The card reader 10 comprises a card enclosure having a main housing 20 which is coupled to a card entrance housing 22. The card entrance housing 22 defines a card entry slot 24 dimensioned for receiving a bank card such as the magnetic stripe card 12 or chip-based smart card 112 by the leading edge 14 or 114 first. The card entrance housing 22 also includes a shutter 26 pivotally coupled to the main housing 20 for controlling access from the card entrance housing 22 to the main housing 20.

When the shutter 26 is in the open position, the bank card (i.e., magnetic stripe card 12 or a chip-based smart card 112) may be transported from the card entrance housing 22 to the main housing 20; whereas, with the shutter 26 in the closed position no card may pass between the card entrance housing 22 and the main housing 20. Once the leading edge 14 or 114 of the bank card 12 or 112 passes the shutter 26, the shutter 26 is released and biased against the top of the bank card 12 or 112 so that the shutter 26 automatically closes once the trailing edge 16 or 116 of the bank card 12 or 112 clears the shutter 26.

The card entrance housing 22 includes three sensors mounted therein for verifying that an object inserted by the customer is actually a bank (or credit) card and has been inserted in the proper orientation. The shutter 26 is preferably only opened when the correct signals are received from two of the three sensors.

The first sensor is a card width detection sensor 28. The card width detection sensor 28 is deflected by the bank card on insertion and ejection of the card. If a customer inserts a card into the card entrance housing 22 then the card width detection sensor 28 detects the presence of this card. The card width detection sensor 28 verifies that the inserted bank card has the correct width.

The second sensor is a input read head 30, in the form of a magnetic flux detector. This input read head 30 is located at a point in the card entrance housing 22 over which the magnetic stripe 18 of the magnetic stripe card 12 should pass before the magnetic stripe card 12 enters the shutter 26. The input read head 30, in combination with controller 60 discussed below, verifies that, when the inserted bank card is a magnetic stripe card 12, it has been correctly oriented (i.e., not upside down or backwards) based on the ability to properly read valid information from the magnetic stripe.

The third sensor is a camera 80 mounted above the card entry slot 24 in the card entrance housing 22 of card reader which generates an image of the upper surface of the inserted bank card to controller 60. The camera 80 is situated to have a clear view of the bank card as it enters the card entry slot 24 of card reader 10. Camera 80 may include a lighting element (e.g., an LED unit) to illuminate the bank card in order to ensure that a good quality image is obtained. Alternatively, camera 80 may be a low light image sensor so that no additional lighting is required. Camera 80 is chosen to provide the ability to capture clear images even when the bank card is inserted quickly and does not have any capacity to store images—thereby reducing potential security risks. Controller 60 receives and processes images from camera 80 (as explained below) to order to determine if the inserted bank card includes a chip in the proper position on the upper surface. This allows controller 60 to verify that the inserted bank card is a chip-based smart card 112 that has been inserted in the proper orientation (i.e., not upside down or backwards).

A controller 60 (shown in FIG. 2) receives the signals from the three sensors (i.e., the card width detection sensor 28, the input read head 30, and the camera 80) and processes such signals to determine if the inserted bank card is in the proper orientation and is either a magnetic stripe card 12 (based on receipt of valid information from input read head 30) or a chip-based smart card 112 (after processing an image from camera 80). Controller 60 causes shutter 26 to open upon this determination, as will be described in more detail below. The card entrance housing 22 also includes a shutter detect sensor 40 for detecting whether the shutter 26 is open or closed.

Referring specifically to FIG. 2, the main housing 20 includes a linear transport mechanism 42 comprising four pairs of rollers 44, 46, 48, 50 and associated stretchable endless belts (not shown) for transporting the magnetic stripe card 12 when it is at least partially within the main housing 20. The main housing 20 defines an entrance/exit slot 52 at one end and a card retention slot 54 at the opposite end. The main housing 20 also includes a card read/write head 56 for reading data from the magnetic stripe card 12 and writing data to a magnetic stripe card 12 as necessary. The main housing 20 also includes a chip reader unit 58 for reading data from a chip-based smart card 112 and writing data to the chip-based smart card 112 as necessary. The main housing 20 also includes multiple sensors (not shown) for accurately locating the position of the magnetic stripe card 12 or the chip-based smart card 112 within the main housing 20. Controller 60 is also provided within, or coupled to, the main housing 20 to control the operation of the other components of the card reader 10, such as the shutter 26, the sensors (i.e., the input read head 30, the card width detection sensor 28, and the camera 80), the linear transport mechanism 42, the magnetic stripe read/write head 56, and the chip reader unit 58.

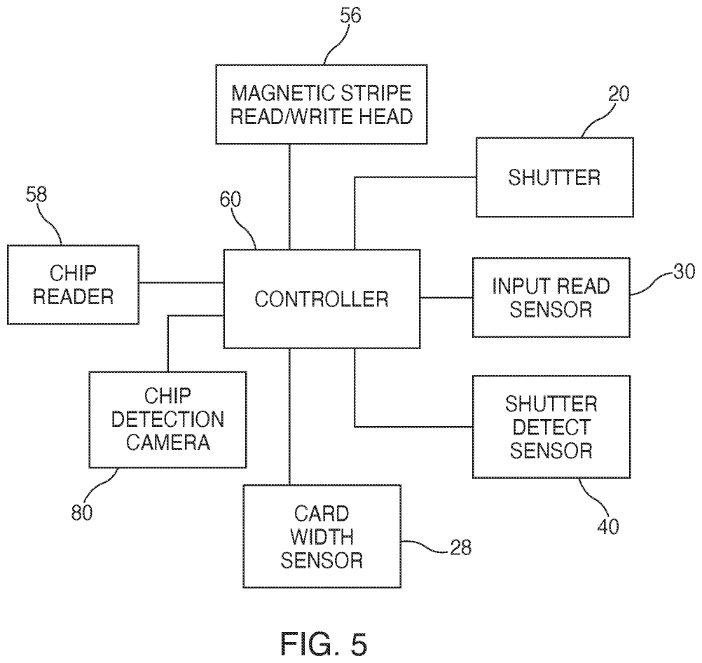

Referring now to the block diagram of FIG. 5, controller 60 is coupled to the input read head 30, the card width detection sensor 28, and the camera 80 in order to perform an initial determination that an inserted bank card has been inserted in a proper orientation and is a valid bank card (either a magnetic stripe card 12 or a chip-based smart card 112). Controller 60 is also coupled to the shutter 26 to control whether the inserted bank card is accepted into main housing 20 by controlling whether the shutter 26 is positioned in an open position or a closed position (the position shown in FIG. 1). Controller 60 is coupled to and receives a feedback signal from shutter detect sensor 40 indicating whether the shutter is in an open or closed position. Finally, controller 60 is coupled to the magnetic stripe read/write head 56 and to the chip reader unit 58.

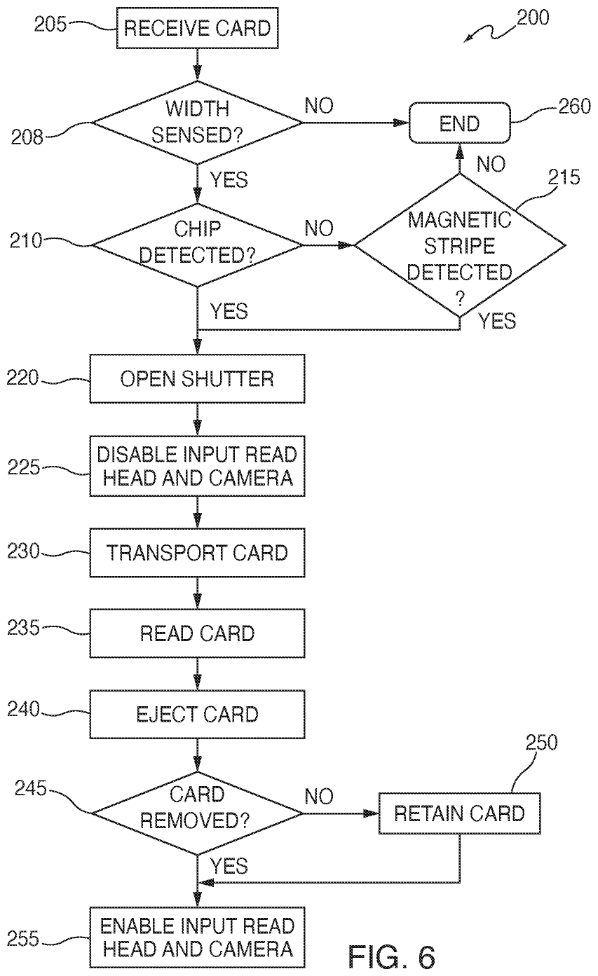

The operation of the card reader 10 will now be described with reference to the flowchart 200 of FIG. 6, which illustrates the steps involved in receiving and reading an inserted bank card. The steps provided allow card reader 10 to accept and read both magnetic stripe cards and chip-based smart cards. In an alternative embodiment intended for applications which only accept chip-based smart cards 112, the input read head 30 and the magnetic stripe read/write head 56 may be omitted from card reader 10, and the steps addressed to such elements described below are also omitted.

Initially, a customer inserts a bank card into the card entry slot 24 of the card entrance housing 22 of card reader 10, so that the card reader 10 receives the inserted bank card at step 205.

The controller 60 continually monitors the card width detection sensor 28 at step 208. If the card width detection sensor 28 is not deflected then the controller 60 takes no action and processing ends at step 260. Insertion of the bank card deflects the card width detection sensor 28, which sends an output to the controller 60 indicating that the inserted bank card (a magnetic stripe card 12 or a chip-based smart card 112) has the correct width. In some embodiments, the card width detection sensor 28 may be omitted when, for example, the insertion slot is designed to only accept bank cards having a particular width. When the card width detection sensor 28 is omitted, step 208 is not necessary.

The controller 60 then receives a camera image from camera 80 and processes the image (as explained below) to determine if the inserted bank card includes a chip in the expected position on the surface of the card at step 210. If the controller 60 determines that the inserted bank card does include a chip in the expected position (i.e., that the inserted bank card is a chip-based smart card in the proper orientation) and the card width detection sensor 28 remains deflected then controller 60 opens the shutter 26 at step 220. Otherwise, controller 60 ascertains if the input read head 30 detects any magnetic flux at step 215. The input read head 30 will detect magnetic flux on the magnetic stripe card 12 if the magnetic stripe card 12 is oriented correctly when it is inserted. If no magnetic flux is detected then the controller 60 takes no action and processing ends at step 260. If magnetic flux is detected and the card width detection sensor 28 remains deflected then the controller 60 opens the shutter 26 at step 220.

The controller 60 then disables the input read head 30 and camera 80 at step 225. Once the input read head 30 and camera 80 have been deactivated, the controller 60 transports the inserted bank card within the main housing 20 at step 230 and allows the shutter 26 to urge against the top of the bank card so that when the bank card clears the shutter 26, the shutter 26 will automatically close.

Once the bank card is fully enclosed by the main housing 20, and the shutter 26 is fully closed, the controller 60 reads the bank card for use in a transaction at step 235. The bank card is read using magnetic stripe read write head 56 when the inserted bank card is a magnetic stripe card 12. The bank card is read using chip reader unit 58 when the inserted bank card is a chip-based smart card 112. In some cases, a chip-based smart card 112 may also include a magnetic stripe to allow the card to be used with older card readers not designed to work with such smart cards. Card reader 10 will always default using the chip reader unit 58 even if the inserted bank card has both a chip and a magnetic stripe.

When the current transaction is completed, the controller 60 then ejects the bank card at step 240 using the linear transport mechanism 42 to present the bank card to the customer. The controller 60 ascertains if the bank card is removed by the customer at step 240, for example, by detecting closure of the shutter 26 using the shutter detect sensor 40. If the customer does not take the bank card within a pre-determined time period (for example, fifteen seconds) then the card reader 10 transports the bank card to the card retention slot 54 for secure storage of the bank card at step 250. If the customer does take the bank card then the controller 60 enables the input read head 30 and camera 80 at step 255.

In an alternative embodiment, the card reader incorporating the card width detection sensor 28, the input read head 30, and the camera 80 may be a DIP style card reader having the magnetic stripe read/write head 56 and the chip reader unit 58 incorporated directly into an exterior throat portion, and the controller may use the signals from the card width detection sensor 28, the input read head 30, and the camera 80 to determine whether to read the inserted bank card or to provide a message to the customer indicating that the card has not been inserted in the proper orientation. In some cases, the card width detection sensor 28 may be omitted and the functionality provided by the input read head 30 may be provided by the actual magnetic stripe read/write head incorporated into the DIP style card reader.

Controller 60 is programmed to use image processing techniques and/or machine learning and real-time image classification to determine if an inserted bank card has a chip in the correct location thereon based on real-time images provided to controller 60 by camera 80. This determination allows controller 60 to verify that the inserted bank card is a chip-based smart card that has been inserted in the correct orientation. This is particularly useful for chip-based smart cards which do not include a magnetic stripe and for bank cards having a metal substrate. The additional processing capability can be used in conjunction with the processing required for signals from the input read head 30 used to detect correct card orientation for magnetic stripe cards. In addition, the ability to detect that an inserted bank card is a chip-based smart card without the need to actually read (or attempt to read) the chip can extend the life of the card reader 10 based on reduced wear of metal contacts within chip reader unit 58.

Machine learning is performed by first generating a set of example inputs (a training set). Here the training set comprises a collection of sample images of bank cards, both chip-based smart cards and magnetic stripe cards without a chip. A set of target classes are then defined, e.g., an object having the size and shape of the chip on the surface of the bank card. Finally, a Machine Learning model is used to learn key features from this image set to perform object detection. When this trained model is later provided with real-time image frames from the camera, it classifies each image of a chip-based smart card.

Image processing techniques may involve generating a profile image having the particular characteristics of a chip-based smart card (i.e., an outline of the chip in the expected position). Each received image may be compared with the profile image to determine if the received image contains those same characteristics, indicating that the bank card represented by the received image is a chip-based smart card. Other imaging processing techniques may be alternatively applied. For example, each image may be processed to identify shapes of objects therein, and each shape compared to a reference shape (i.e., the expected shape of the chip). If an object is found having a shape corresponding to the reference shape at the expected location in the image, it is concluded that the bank card represented by the received image is a chip-based smart card.

In a further embodiment, the addition of camera 80 to card reader 10 may provide an additional fraud detection feature. In particular, controller 60 may be programmed to process the images from the camera 80 in order to determine when a skimmer has been inserted onto the card reader. Skimmers are typically mounted by thieves on or over an exterior bezel of a magnetic card reader device (and at least partially into the throat of the card reader) and are designed in a way to match or hide the original bezel so that a user does not realize that the skimmer is in place before the use thereof. When controller 60 determines, from processing the images provided by camera 80, that a foreign object has been inserted into the throat of the card reader, an alarm can be provided and/or the associated self-service terminal may be temporarily disabled pending inspection.

Although the present disclosure has been particularly shown and described with reference to the preferred embodiments and various aspects thereof, it will be appreciated by those of ordinary skill in the art that various changes and modifications may be made without departing from the spirit and scope of the disclosure. It is intended that the appended claims be interpreted as including the embodiments described herein, the alternatives mentioned above, and all equivalents thereto.

What is claimed is:

1. A card reader, comprising:
a camera mounted in a housing adjacent to a card entry slot formed in the housing, the camera mounted in position to allow an image to be taken of an upper surface of each bank card inserted into the card entry slot;
a chip reader unit for reading a chip-based smart card; and
a controller coupled to the camera to receive images therefrom and to the chip reader unit, the controller processing the images received from the camera to determine when the inserted bank card is a chip-based smart card in a proper orientation, the controller enabling the chip reader unit upon determining that the inserted bank card is a chip-based smart card in the proper orientation.

2. The card reader of claim 1, wherein the controller processes the image received from the camera to determine when the inserted bank card is a chip-based smart card in the proper orientation based on machine learning.

3. The card reader of claim 1, wherein the controller processes the image received from the camera to determine when the inserted bank card is a chip-based smart card in the proper orientation based on image processing.

4. The card reader of claim 1, further comprising an input read head mounted in the housing adjacent to the card entry slot, the input read head mounted in position to sense a magnetic stripe on a lower surface of the bank card inserted into the card entry slot by detecting magnetic flux therefrom.

5. The card reader of claim 4, wherein the controller is coupled to the input read head to receive a signal from the input read head based on whether magnetic flux could be detected from a magnetic stripe on the inserted bank card, the controller determining that the inserted bank card is a magnetic stripe card in a proper orientation upon receipt of a signal from the input read head confirming that magnetic flux was read from the inserted bank card.

6. The card reader of claim 5, further comprising a magnetic stripe read/write head for reading from and writing to a magnetic stripe on a magnetic stripe card inserted into the card reader.

7. The card reader of claim 6, wherein the controller is coupled to the magnetic stripe read/write head, the controller enabling the magnetic stripe read/write head upon determining that the inserted bank card is not a chip-based smart card in the proper orientation and that the inserted bank card is a magnetic stripe card in the proper orientation.

8. The card reader of claim 1, further comprising a card width detection sensor mounted in the housing adjacent to the card entry slot, the card width detection sensor providing an output signal indicating that a card inserted into the card entry slot has a width corresponding to the width of a bank card.

9. The card reader of claim 8, wherein the controller is coupled to the card width detection sensor and processes the image received from the camera to determine when the inserted bank card is a chip-based smart card in the proper orientation only when the output signal from the card width detection sensor indicates that the card inserted into the card entry slot has a width corresponding to the width of a bank card.

10. The card reader of claim 5, further comprising a card width detection sensor mounted in the housing adjacent to the card entry slot, the card width detection sensor providing an output signal indicating that a card inserted into the card entry slot has a width corresponding to the width of a bank card.

11. The card reader of claim 10, wherein the controller is coupled to the card width detection sensor, the controller processing the image received from the camera to determine when the inserted bank card is a chip-based smart card in the proper orientation or determining that the inserted bank card is a magnetic stripe card in the proper orientation upon receiving a signal from the input read head confirming that magnetic flux was read from the inserted bank card only when the signal from the card width detection sensor indicates that the card inserted into the card entry slot has a width corresponding to the width of a bank card.

12. The card reader of claim 1, wherein the controller generates an alarm signal upon determining that the image received from the camera shows that a foreign object has been inserted into card entry slot.

13. A method of reading a bank card, comprising the steps of:
generating an image of an upper surface of a bank card inserted into a card entry slot formed in a housing of a card reader;
processing the generated image to determine when the inserted bank card is a chip-based smart card in a proper orientation;
enabling a chip reader unit upon determining that the inserted bank card is a chip-based smart card in the proper orientation; and
reading information from a chip on the inserted bank card.

14. The method of claim 13, wherein the image is generated by a camera mounted in the housing adjacent to the card entry slot.

15. The method of claim 14, wherein the generated image is processed by a controller coupled to the camera.

16. The method of claim 13, wherein the step of processing the generated image to determine when the inserted bank card is a chip-based smart card in the proper orientation is performed based on machine learning.

17. The method of claim 13, wherein the step of processing the generated image to determine when the inserted bank card is a chip-based smart card in the proper orientation is performed based on image processing.

18. The method of claim 13, further comprising the step of sensing a magnetic stripe on a lower surface of a bank card inserted into the card entry slot by detecting magnetic flux therefrom.

19. The method of claim 18, further comprising the step of determining that the inserted bank card is a magnetic stripe card in a proper orientation upon receiving a signal confirming that magnetic flux was read from the inserted bank card.

20. The method of claim 14, further comprising the step of generating an alarm signal upon determining that the image received from the camera shows that a foreign object has been inserted into card entry slot.
